(19) United States
(12) Patent Application Publication
(10) Pub. No.: US 2007/0061755 A1
(43) Pub. Date: Mar. 15, 2007

(54) Reading mode for electronic documents

(75) Inventors: Roberto C. Taboada, Duvall, WA (US); Bertille Nettie Fernandes, Bellevue, WA (US); Jason Barnett, Renton, WA (US); Joe Keng Yap, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/223,396

(22) Filed: Sep. 9, 2005

(51) Int. Cl. G06F 17/00

(52) U.S. Cl. 715/818; 345/901

(57) ABSTRACT

An improved reading mode for electronic documents is provided. An electronic document is displayed in one or more discrete pages to provide a “look and feel” of reading a physical book or other document. Page turning controls are provided on each displayed page for turning a single page or for rapidly turning numerous pages. A page may be pinned so that the pinned page remains displayed while an adjacently displayed page is turned. Reading pointer controls and reading underlines may be deployed adjacent to and under selected text, respectively, for providing helpful reading reference points. Bookmarks may be deployed adjacent to text or images of interest in one or more pages of a displayed electronic document.

### BACKGROUND

With the advent of the computer age, computer and software users have grown accustomed to user-friendly software applications that help them write, calculate, organize, prepare presentations, send and receive electronic mail, make music, and the like. For example, modern electronic word processing applications allow users to prepare a variety of useful documents. Modern spreadsheet applications allow users to enter, manipulate, and organize data. Modern electronic slide presentation applications allow users to create a variety of slide presentations containing text, pictures, data or other useful objects. Modern database applications allow users to store, organize and exchange large amounts of data.

In recent years, many users of such software applications having moved away from printing hard copies of electronic documents for reading and review. An increasing number of people now read electronic documents and other materials on their computer display screens in the same manner they would have read a hard copy of a book, magazine, manuscript, or report in the past. This is especially true with the use of modern tablet type computers that allow users to hold the computer as they would normally hold a document or book. Unfortunately, modern software applications, as described above, do not provide an enjoyable reading experience to users as compared to the experience of reading the physical pages of a book or other document. For example, if a user reads a document having multiple pages using her word processing application, she may not flip through the pages of the document or easily jump from one page to another. For typical software applications, such as word processing applications, the user must scroll up or down through the text of the document, and the user must use a find type function to locate particular content in the document.

In addition, because typical software application user interfaces expose a number of functionality buttons and controls for accessing various functionalities of the software application, the “look and feel” of a document displayed in a typical application user interface workspace does not provide a similar experience to the “look and feel” of holding a book or other hard copy document. In addition, users of hard copy documents enjoy marking or highlighting portions of documents and tagging or bookmarking pages or portions of documents for indicating a last position read or for indicating a particular portion of a given document that is important to the reader. Some prior software applications allow for annotating text or objects in a document with various markings and highlightings, but the user experience associated with reading and handling a physical copy of the document is not achieved.

It is with respect to these and other considerations that the present invention has been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments of the present invention solve the above and other problems by providing an improved reading mode for electronic documents. According to aspects of the invention, a document displayed by a software application, such as a word processing application or notes application, may be displayed in a reading mode. In the reading mode, the pages of the document may be displayed such that a single page is displayed at a time or two pages are displayed at a time in side-by-side orientation to simulate pages of an open book, magazine, manuscript, report, memorandum, and the like. If desired, normal user interface buttons and/or controls of the displaying application may be suppressed from view to provide a full screen view of the displayed pages.

According to other aspects of the invention, a page turning control is displayed on each page which, when selected, causes displayed pages to turn exposing the next page in sequence. To simulate turning pages of a physical book or document, selection of outside margins of a displayed page also causes the displayed page to turn. According to one aspect, a page turning animation is provided to further provide the “look and feel” of turning a physical page in a book or other document.

According to other aspects of the invention, when the document is displayed in reading mode, the document is locked from editing according to the normal editing functions of the displaying application. A limited number or tools may be provided for annotating the document, including electronically entered notes and highlighting, comments, and the like, to further simulate the types of actions that are often taken with respect to physical documents.

According to other aspects of the invention, a displayed document may be navigated by jumping to different pages, sections, headings, bookmarks, comments, changes, or other features of a displayed document. In addition, a number of reading enhancement components may be applied to pages of the displayed document to enhance the reading experience, including electronic bookmarks, underlines, and reading pointers. A zoom control may be provided for allowing the zooming in or out on an object in the displayed document such as a picture or other graphical object.

These and other features and advantages, which characterize the present invention, will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a block diagram of an exemplary computing operating environment for the present invention.

FIG. 2 illustrates a computer screen display showing an electronic document displayed in reading mode.

FIG. 3 illustrates a computer screen display showing an electronic document displayed in full screen reading mode.

FIG. 4 illustrates a computer screen display showing an electronic document displayed in reading mode and showing a page animation associated with a turning page.

FIG. 5 illustrates a computer screen display showing a drop-down menu containing one or more navigation commands for navigating through a displayed electronic document in reading mode.

FIG. 6 illustrates a computer screen display of a drop-down menu showing a set of commands available for use in association with an electronic document displayed in reading mode.

FIG. 7 illustrates a computer screen display of a drop-down menu showing a set of commands available for use in association with an electronic document displayed in reading mode.

FIG. 8 illustrates a computer screen display showing a displayed electronic document containing an embedded image.

FIG. 9 illustrates a computer screen display showing a displayed electronic document having an enlarged embedded image.

### DETAILED DESCRIPTION

As briefly described above, embodiments of the present invention are directed to an improved reading mode for electronic documents displayed in a software application user interface. In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

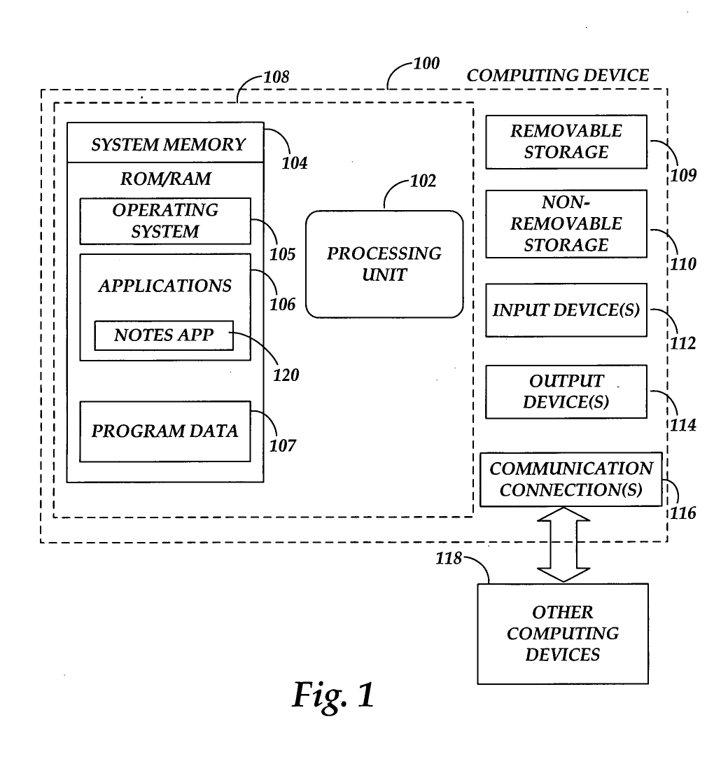

Referring now to the drawings, in which like numerals refer to like elements through the several figures, aspects of the present invention and an exemplary computing operating environment will be described. FIG. 1 and the following discussion are intended to provide a brief, general description of a suitable computing environment in which the invention may be implemented. While the invention will be described in the general context of program modules that execute in conjunction with an application program that runs on an operating system on a personal computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Embodiments of the invention may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

With reference to FIG. 1, one exemplary system for implementing the invention includes a computing device, such as computing device 100. In a basic configuration, the computing device 100 typically includes at least one processing unit 102 and system memory 104. Depending on the exact configuration and type of computing device, the system memory 104 may be volatile (such as RAM), non-volatile (such as ROM, flash memory, etc.) or some combination of the two. System memory 104 typically includes an operating system 105 suitable for controlling the operation of a networked personal computer, such as the WINDOWS® operating systems from MICROSOFT CORPORATION of Redmond, Wash. The system memory 104 may also include one or more software applications 106, 120, and may include program data 107. This basic configuration is illustrated in FIG. 1 by those components within dashed line 108.

According to embodiments of the invention, the application 106 may comprise many types of programs, such as an electronic mail program, a calendaring program, an Internet browsing program, and the like. An example of such programs is OUTLOOK® manufactured by MICROSOFT CORPORATION. The application 106 may also comprise a multiple-functionality software application for providing many other types of functionalities. Such a multiple-functionality application may include a number of program modules, such as a word processing program, a spreadsheet program, a slide presentation program, a database program, and the like. An example of such a multiple-functionality application is OFFICE™ manufactured by MICROSOFT CORPORATION. A notes application 120 is illustrated for entering, storing and retrieving typed or handwritten notes or other information in accordance with embodiments of the present invention. An example notes application 120 includes ONENOTE® manufactured by MICROSOFT CORPORATION.

The computing device 100 may have additional features or functionality. For example, the computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included. These devices are well known in the art and need not be discussed at length here.

The computing device 100 may also contain communication connections 116 that allow the device to communicate with other computing devices 118, such as over a network in a distributed computing environment, for example, an intranet or the Internet. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

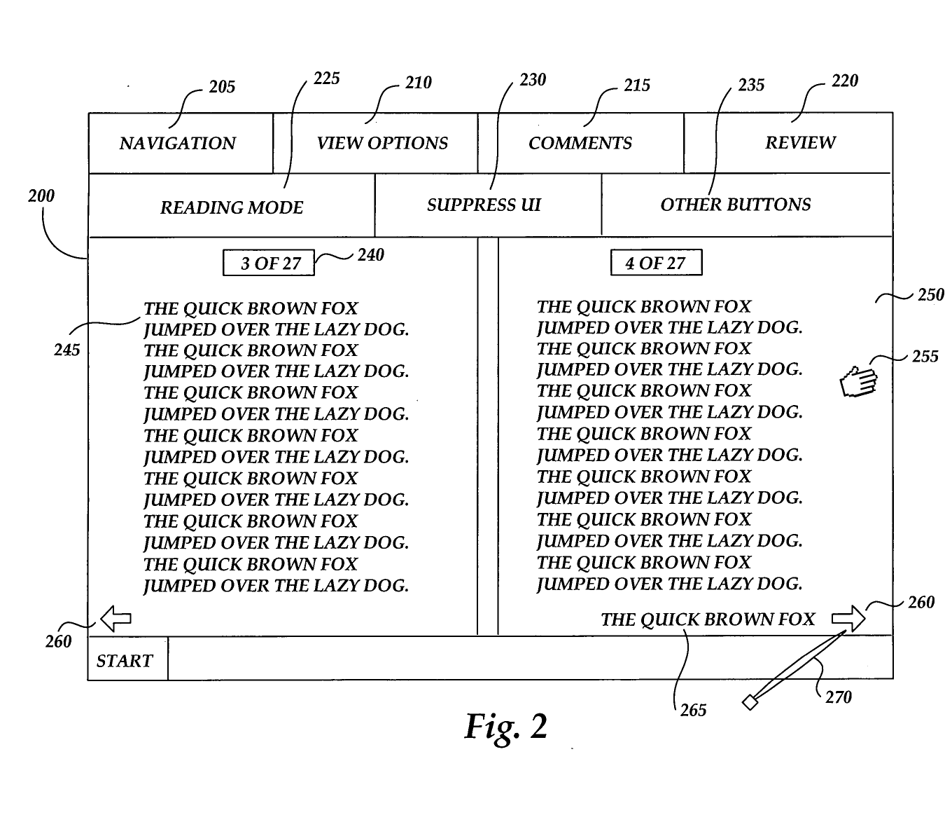

FIG. 2 illustrates a computer screen display showing an electronic document displayed in reading mode according to embodiments of the present invention. The user interface 200 represents a user interface associated with a software application such as a word processing application, a notes application, or any other suitable application for displaying electronic documents for reading or reviewing, as described herein. The example user interface 200 is for purposes of example only and is not limiting of the many different layouts and styles of user interfaces in which an electronic document may be displayed according to embodiments of the present invention. Thus, the controls, buttons, and other layout features illustrated in FIG. 2 are not to be taken in a limiting sense and are not restrictive of the invention as claimed.

Referring to the user interface 200 illustrated in FIG. 2, buttons or controls for utilizing functionality of the displaying software application are situated along the top of the user interface 200. For example, a navigation button 205, a view options button 210, a comments button 215, and a review button 220 are illustrated. Beneath the first row of buttons or controls is a second row of buttons or controls including a reading mode button 225, a suppress user interface button 230, and an others button control 235. As described above, the illustrated buttons and controls 205-235 are for purposes of example only.

According to embodiments of the present invention, an electronic document 245, such as a book, letter, manuscript, memorandum, technical document, and the like is displayed in the display space of the user interface 200. In a normal mode of operation of the displaying software application, for example, a notes application, a word processing application, and the like, functionalities of the displaying software application, for example, editing functionalities such as cut, copy, paste, formatting, spell checking, grammar checking, and the like are available for operation on the contents of the displayed document. According to embodiments of the present invention, a reading mode may be selected, for example, by selecting the reading mode button 225, for displaying the document 245 in the user interface 200 so that a user may read and review the displayed document in a manner similar to reading and reviewing the physical pages of a physical document.

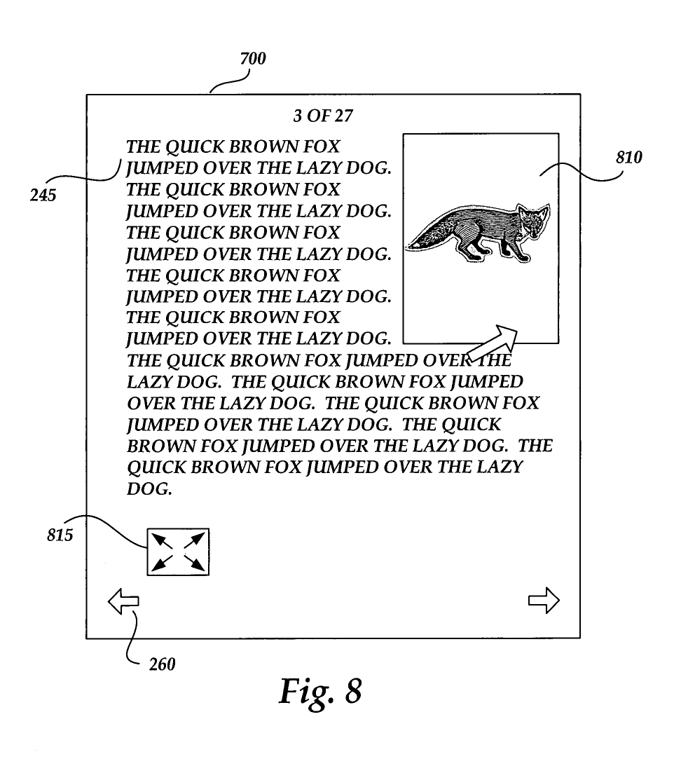

Referring still to FIG. 2, once the document is placed into the reading mode, the document is displayed in discrete pages in a format similar to the display of pages of text in a physical book where text and embedded objects are displayed with margin space 250 surrounding the displayed text or objects to simulate the look of pages displayed in a book. According to one display mode, the display area of the user interface 200 may be split for providing two displayed pages in side-by-side orientation, as illustrated in FIG. 2. Alternatively, the display mode may be set for displaying a single page at a time, as illustrated below in FIG. 8.

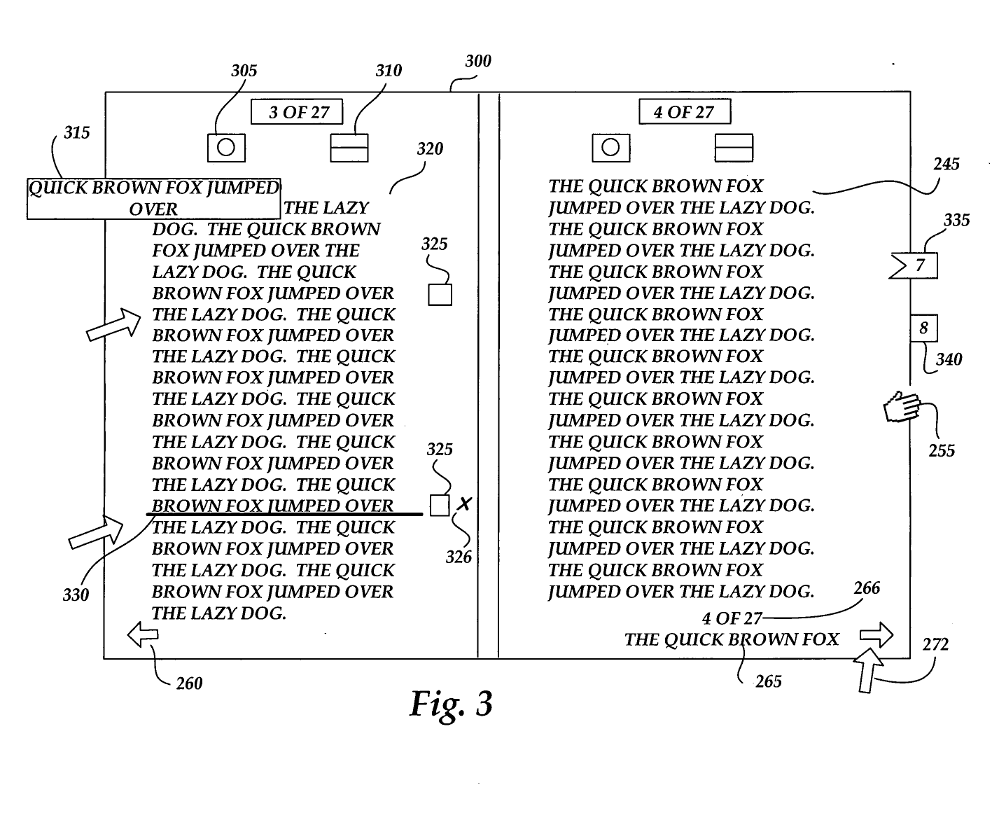

As described above, user interface components including buttons, controls, and tools may be displayed in the user interface 200 for accessing functionality of the displayed software application, for example, a word processing application or notes application. According to an alternative embodiment, user interface buttons, controls, and tools may be suppressed from view to provide a full screen reading mode, as illustrated in FIG. 3. For example, by selecting a “suppress user interface” button 230, illustrated in FIG. 2, or similar button or control provided by the displaying software application, all user interface buttons, controls, or tools normally displayed in the user interface 200 are suppressed from display to provide the full screen display mode illustrated in FIG. 3. With the full screen reading mode, the full amount of display space provided by the user's computer display screen may be utilized for displayed text or information 245 of the displayed electronic document. Thus, the “look and feel” of reading a book, manuscript, memorandum, or other document is further enhanced.

Once an electronic document is displayed in reading mode, as illustrated in FIG. 2 or 3, the pages of the displayed document may be turned forward or backward by selecting page turning arrows (controls) 260 displayed in the lower left-hand and lower right-hand corners, respectively, of the document display area. As should be appreciated, the page turning arrows may be selected by clicking a mouse cursor on the page turning arrows or by depressing an electronic pen 270 to the page turning arrows 260. If a single selection of a page turning arrow is made, a single page turn will result. As should be appreciated, if the document is displayed in the two-page format, as illustrated in FIGS. 2 and 3, turning a page will result in the display of two different pages. Alternatively, if the user places the mouse cursor or other pointing device onto the page turning arrow and holds the selected page turning arrow, then a continuous turning of pages will result until the user releases the pointing and selecting device. That is, as long as a given page turning arrow is selected and held by the user, pages of the document will continuously and quickly turn in a manner similar to flipping through the pages of a physical book or other document.

According to embodiments of the present invention, in order to further enhance a “look and feel” of turning the pages of a physical book or other document, margin space 250 along the outer (left-most or right-most) edges of a displayed page is designated as a control which, when selected, causes an associated page to turn. That is, referring to FIG. 2, if a user selects a mouse cursor or depresses an electronic pen to the margin space 250 along the outside edge of a displayed page, the page will be turned in the same manner as it will be turned if the user selects the page turning arrow 260. Thus, just a user is able to turn the page of a physical book or other document by grasping the outer edge of a page with his/her fingers, the pages of the electronic document 245 displayed according to the present invention may be turned by selecting the outer edge of a displayed page. According to one embodiment, when a mouse cursor is moved to a position along an outer edge of a displayed page, the mouse cursor may be dynamically changed into a visually descriptive icon, such as the hand icon 255 illustrated in FIG. 2. The use of such a visually descriptive icon 255 provides a visual reference that the mouse cursor may now be used for turning the page once it is placed along the outer edge of the displayed page. As should be appreciated, the page turning features described herein is equally applicable to turning pages in a forward or in a backward direction.

Referring to FIGS. 2 and 3, according to an embodiment, a displayed page may be “pinned” to allow the pinned page to remain displayed while the adjacently displayed page turns to a different page. For example, referring to FIG. 3, page 3 of 27 of the illustrated document may be pinned. The user may then turn page 4 of 27 to other pages, for example, pages 5, 6, 7 and so on, and pinned page 3 of 27 will remain displayed. Thus, if the user wants to compare the content of page 3 to the content of page 8, for example, the user may pin page 3 and turn the adjacent page to page 8 for comparing the two pages. As should be appreciated, pinning pages may be performed in both directions. For example, page 4 of 27 may be pinned, and the adjacent page 3 of 27 may be turned to other pages such as pages 2 or 1.

According to another embodiment of the present invention, a number of pages may be pinned together so that the pinned pages flip or turn as a unit when the page turning arrow or when the outside margin of the displayed page are selected, as described above. For example, if the user desires to pin or clip pages 5 through 10 of the displayed electronic document together so that those pages are turned as a unit, the user may select to pin those pages together. Thus, if the user selects the page turning arrow or selects the outside margin area of page 5, pages 5 through 10 will turn simultaneously so that the next displayed page will be page 11.

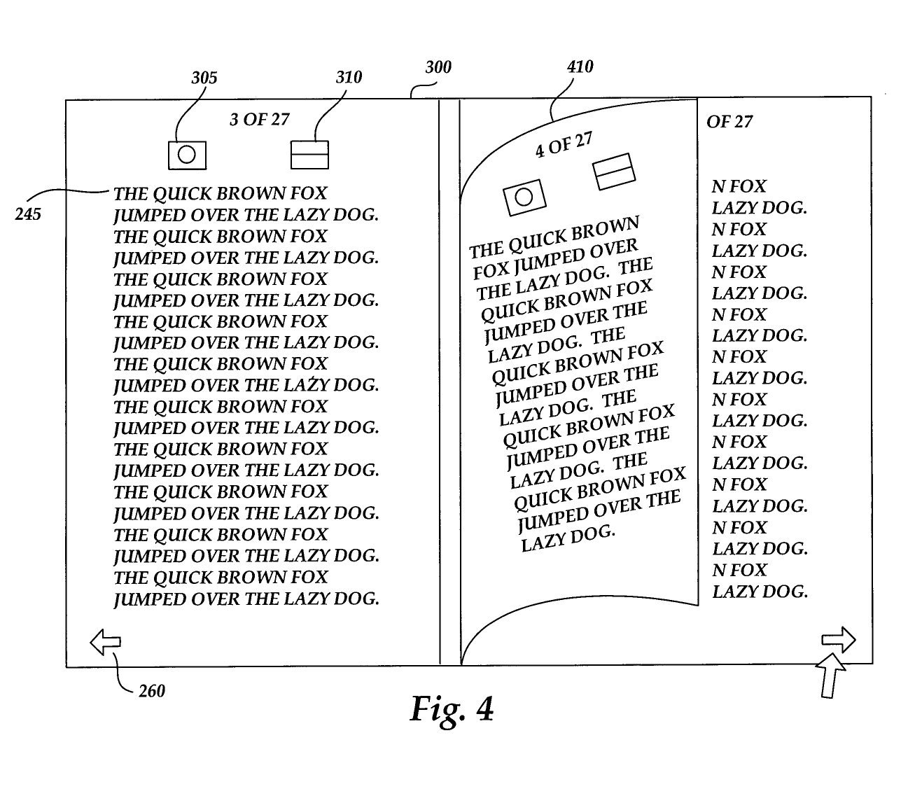

Referring now to FIG. 4, when a single page or a group of pinned pages are turned, as described above, according to one embodiment, a page animation is displayed for visually indicating the movement or turning of a page or group of pages from one side of a displayed document to the other. As illustrated in FIG. 4, when the page 410 is turned by selecting the turning arrow 260, or by selecting the outer margin of the page 410, the page animation causes a visual appearance of the page 410 turning from one side to the other to further enhance the “look and feel” of turning the pages of a physical book or document. As should be appreciated, if the user selects a single page or a group of pinned pages for turning, the page animation may be set to operate at a first speed for providing a first visual indication of a turning page. On the other hand, if the user selects and holds the page turning arrow so that pages continue to turn until the user releases the page turning arrow, the page turning animation may be set to a faster operating mode so that the page turning animation does not impede the fast page turning desired by the user who has selected and held the page turning arrow 260.

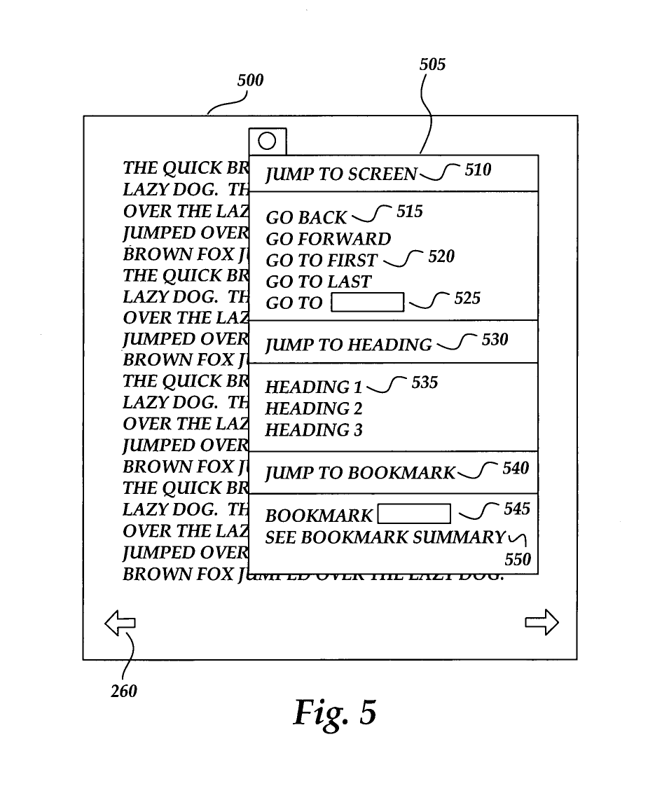

Once a document is displayed in reading mode, as described above with reference to FIGS. 2-4, a navigation menu 505 may be deployed for navigating to various locations in the displayed document. As illustrated in FIG. 5, the dropdown navigation menu 505 is illustrated as deployed from the top of the display screen 500 in which is displayed a document in reading mode. Once the navigation menu 505 is deployed, a user may navigate to various locations in the displayed document according to a variety of navigation properties. The “jump to screen” navigation section allows the user to select from a number of different screens to which the user would like to automatically navigate. A “go back” control 515 causes a display of the last displayed page. A “go forward” control causes a display of the next page. A “go to first” control 520 causes a display of the first page in the displayed document, and a “go to last” control causes a display of the last page in the document. A “go to” control 525 allows a user to enter a particular page number to which the user would like to automatically navigate.

A next section titled “jump to heading” allows for navigation to one or more headings contained in the displayed document. For example, selection of the “heading 1” control 535 causes an automatic navigation to the page in the displayed document containing the selected heading. As should be appreciated, the heading titles illustrated in the “jump to heading” section of the menu 505 are for purposes of example only. According to an actual embodiment of the present invention, this section is populated with actual headings contained in the displayed document when the menu 505 is deployed.

A third section titled “jump to bookmark” allows for automatically navigating to individual portions of pages contained in the displayed document marked by specified electronic bookmarks. For example, the “bookmark” control 545 may be used for specifying the identification of a given bookmark for allowing the automatic navigation to and display of a page in the document containing the specified bookmark. A “see bookmark summary” control 550 allows for a display of information associated with each bookmark contained in the displayed document for allowing the selection of a particular bookmark to which navigation is desired.

Once a particular navigation location is selected, for example a particular page, a particular heading, or a particular bookmark, the page containing the selected navigation item is automatically displayed for review. As should be understood by those skilled in the art, the navigation properties illustrated in the menu 505 are for purposes of example only and are not limiting of the different types of properties on which navigation may be executed. For example, navigation may be made based on changes displayed in a “track changes” version of a displayed document. Navigation may be made to comments applied to portions of the displayed document. Navigation may be made based on objects, for example, embedded pictures, contained in a displayed document. As should be appreciated, any number of data items contained in a given displayed document may be used for points of reference to which navigation may be made according to embodiments of the present invention.

Referring back to FIGS. 2, 3, and 4, a number of user interface components are displayed and/or are available for display with respect to a document displayed in reading mode for enhancing the reading and reviewing experience. As shown in FIG. 2, once pages of a given document are displayed in reading mode, a number of features are provided for giving the displayed document a “look and feel” of a physical book, manuscript, memorandum, document and the like. At the top of each displayed page, a page number box 240 is provided for giving a user a quick reference point as to the page or pages that are currently displayed. For example, referring to FIG. 2, the page number box 240 on the left-most displayed page includes the numbering “3 of 27” to identify to the user that the displayed page is page 3 of a total of 27 pages for the displayed document. As should be appreciated, the page numbering box 240 may be located in other locations in the document, for example, the bottom of each page.

In the lower right-hand corner, a reference text display 265 is displayed for providing a user an additional reference point as to the portions of text or information that are presently displayed for the document. For example, the reference text display 265 may include a first appearing heading in the displayed information, or the reference text display 265 may include a portion of a first sentence displayed in the document 245 for providing a user a quick reference point as to the nature of the information contained in the page(s) presently displayed for the document. In addition, as illustrated in FIG. 3, a page numbering display 266 may also be provided near the reference text display for allowing a user to quickly determine the page and reference information for the page to which the user has turned. This is particularly effective when the user has selected and held a page turning arrow 260 to cause a rapid turning of pages because, when the user releases the page turning arrow to stop at a given page, the user quickly sees a page number and/or reference information near the released page turning arrow to give the user a reference as to the nature of the page at which the user has stopped.

Referring to FIG. 3, according to one embodiment, in the upper left-most portion of a displayed document, a text box 315 may be dynamically deployed for containing a sentence or a prescribed number of sentences of text that are displayed on the preceding page for providing a user context as to the nature of the first text entry displayed on the currently displayed page. For example, if a user is reviewing the document illustrated in FIG. 3, and the user is taken away from the document for a brief period for a meeting or telephone call, when the user returns and looks to a partial portion of a sentence, for example, in the upper left-most portion of the displayed document, the user may have difficulty remembering the context for that portion of text. In order to enhance the reading experience, if the user focuses a mouse cursor or electronic pen to the text entry displayed in the upper left-most portion of the displayed document, the text box 315 is deployed for containing one or more sentences immediately preceding the focused on sentence for providing reading context to the user. Thus, the user is not required to turn the displayed page back to the previously displayed page for reviewing one or more sentences of text immediately preceding the presently displayed sentence.

Alternatively, if the text entry contained in the upper left-most portion of the displayed page is a partial portion of a sentence, and the user focuses on the partial portion of the sentence, the preceding portion of the sentence that is displayed on the previous page may be displayed immediately above the focused on portion of the sentence and may be color coded, for example, “grayed out” for providing the user the beginning portion of the sentence that is not displayed in the electronic document. As should be appreciated, the text box 315, may be provided in the lower right-most portion for providing an immediately following one or more sentences of text so that the user does not have to turn to the next page to finish a sentence or paragraph. Likewise, if only a portion of a sentence is displayed in the lower right-most portion of the displayed document, the remaining portion of the sentence may be displayed in a color coded fashion for providing the user the remaining portion of the sentence without the need for turning the page.

Referring still to FIG. 3, along the right-hand side of the left page is illustrated a reading pointer button (control) 325. According to one embodiment of the present invention, as a cursor or electronic pen pointer is moved down the screen along the text of a displayed document, the reading pointer button 325 is dynamically displayed at the position of the cursor or pointer. The reading pointer button provides a quick reference point as to the present location of reading or review in the displayed document. According to one embodiment, the reading pointer button is displayed after a prescribed number of lines of text have been passed with the cursor or pointer. For example, the reading pointer button may be displayed after every 5 lines have been crossed by the cursor or pointer.

Once the reading pointer button 325 is deployed, the button remains deployed until the user selects a different portion of the document or selects some other button or control, or if the user continues to move the cursor or electronic pointer down the text of the displayed page, the reading pointer button 325 will dynamically change positions to follow the cursor or pointer. For example, if the user is required to move away from the current document for reviewing a different document or for attending a meeting or answering a telephone call, or the like, when the user returns to the presently displayed document, the reading pointer button will be deployed, as illustrated in FIG. 3, for providing a reference point to the user as to the last position in the document being read or reviewed by the user.

According to an embodiment, if the user selects the deployed reading pointer button 325 by clicking a mouse cursor on the button or by depressing an electronic pen to the button, the underline 330 is dynamically displayed under the line of text immediately adjacent to the displayed reading pointer button. According to one embodiment, if the displayed page is a single page of information, the line may be color-coded according to a first color, for example, red, and if the page is pinned page, the line may be color-coded according to a different color, for example, blue, for distinguishing a single page from a pinned page. The deployed underline 330 provides the user with a method for emphasizing the underlined text during the user's review of that text.

If the user continues to move the electronic pointer or cursor arrow down the page, the underline 330 will disappear until redeployed at a different position upon selecting the associated reading pointer button 325. If desired, the underline 330 may be frozen or maintained in a present position by selecting the reading pointer pin 325 a second time after the first selection for initially deploying the underline 330. According to alternative embodiments, the underline 330 may be frozen or maintained by selecting the current line of text after the underline 330 is deployed. As should be appreciated, it may be desired that the underline 330 be frozen in place and left in its current position after the user moves the mouse cursor or electronic pointer to a different location for purposes of emphasizing that line of text to the user upon a return to that page in the document. In order to dismiss the underline 330 after it has been frozen in place, as described herein, the reading pointer button 325 may be selected a third time after the selection of the button 325 that froze the underline 330 in its present position, or a subsequent selection of the line of text under which the underline 330 is deployed may be used for removing the underline 330 from display. Additionally, an additional selection icon such as a “X” icon 326 may be deployed next to the button 325 when the underline 330 is deployed. Selection of the “X” icon may then cause the deployed underline 330 to be dismissed.

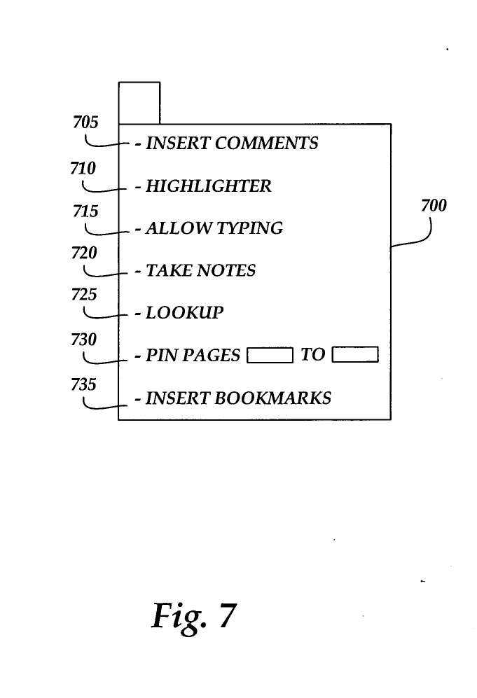

Referring still to FIG. 3, along the right-most edge of the right page bookmarks 335, 340 are illustrated that have been deployed on respective pages for marking a portion of text for subsequent reading or review. The bookmark 335 illustrates a bookmark deployed on a presently displayed page of the electronic document 245. The bookmark 340 illustrates a bookmark deployed on a page following the presently displayed page. In order to deploy a bookmark 335, 340 a selection of a position in the presently displayed text or other data is made using a mouse cursor or electronic pointing device 270 followed by selection of a bookmark insertion functionality, as described below with reference to FIG. 7. As illustrated in FIG. 3, each deployed bookmark is provided an identification, for example, an identification number, for subsequently locating the bookmark and for subsequently navigating to the portion of the electronic document marked with the bookmark, as described above with reference to FIG. 5.

As briefly described above, when an electronic document is placed into reading mode, normal functionality of the displaying software application, such as editing functionality and formatting functionality, is disabled from operation. However, according to embodiments of the present invention, certain functionalities associated with using an electronic document in reading mode are made available. If the normal user interface for the displaying application is not suppressed, as illustrated in FIG. 2, a button or control may be provided such as the “other buttons” control 235 for deploying one or more drop-down menus of functionalities available for use with a displayed electronic document in reading mode. As illustrated in FIG. 3, if the electronic document is displayed in full screen mode where the normal user interface components of the displaying application are suppressed from view, one or more functionality icons 305, 310 may be displayed for selectively deploying one or more drop down menus of functionalities that may be used with the electronic document in reading mode.

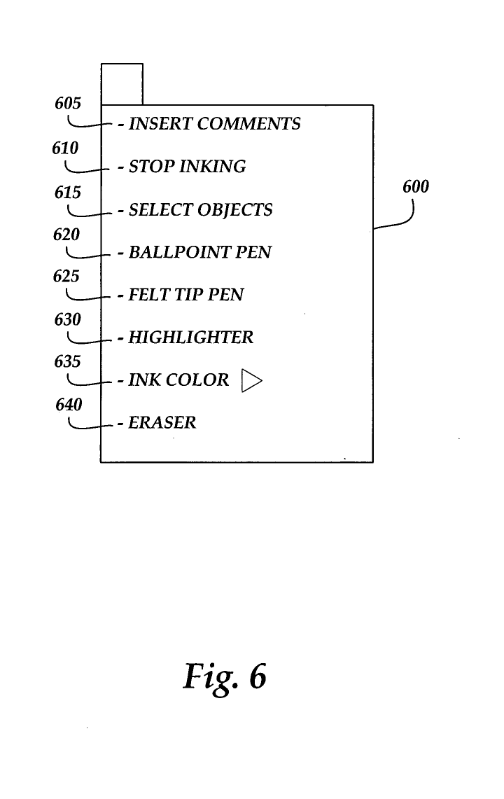

Referring now to FIG. 6, a first drop down menu 600 is illustrated for providing a number of functionalities that may be used with respect to an electronic document displayed in reading mode as described herein. An “insert comment” button 605 allows for the insertion of a comment in a portion of the displayed electronic document. A “stop inking” button 610 allows a user to selectively disable the use of an electronic pen device. Use of different electronic writing systems, for example, ball point pen, felt tip pen and highlighter may be selected using the buttons 620, 625, 630, illustrated in the menu 600. An eraser button 640 may be selected for erasing electronic comments, highlighting and other markings applied to the electronic document.

Another example drop down menu 700 is illustrated in FIG. 7. An “allow typing” button 715 allows a user to enable a typing functionality of the displaying application for allowing the user to type additional text into the displayed document. A lookup function 725 allows the user to find information contained in the displayed document. A pin pages button 730 allows a user to select a page for pinning to keep the page on display as an adjacent page is turned, as described above, or alternatively, for pinning one or more pages together, as described above. An insert bookmarks button 735 allows for deploying a bookmark onto a desired page for marking a portion of the page for future reference, as described above with reference to FIG. 3. As should be appreciated by those skilled in the art, the functionality buttons and controls illustrated in FIGS. 6 and 7 are for purposes of example only and are not limiting of the number of different functionalities that may be made available for use with an electronic document displayed in reading mode, as described herein.

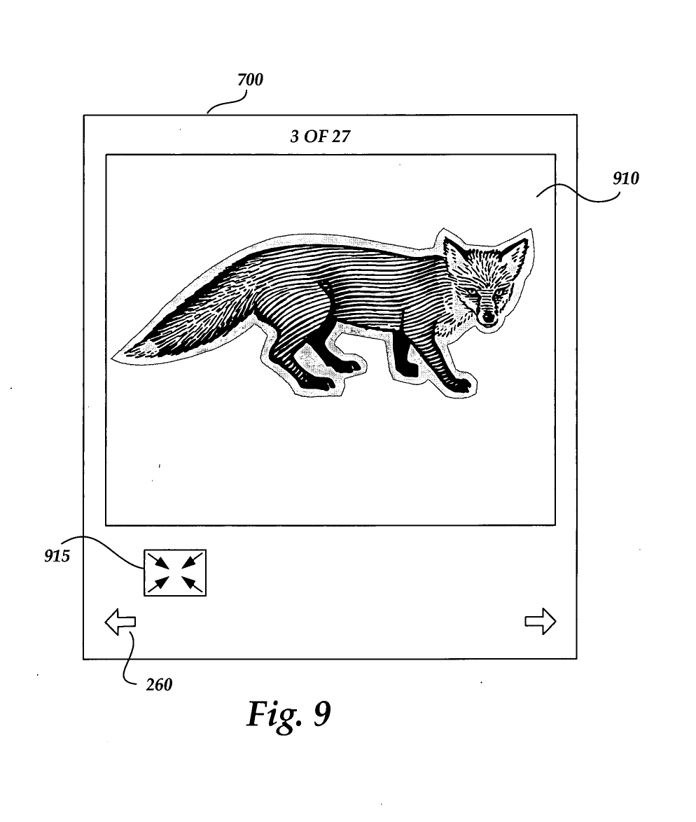

Referring now to FIG. 8, a display screen 700 is illustrated in which an electronic document is displayed in a single page mode as opposed to the 2-page mode illustrated in FIGS. 2 and 3 above. An image 810 is illustrated in the upper right-hand corner of the document 245. As should be appreciated, often an image displayed in an electronic document is too small to allow a user to appreciate details of the embedded image 810. According to embodiments of the present invention, a zoom out control 815 may be automatically deployed for any page of the electronic document containing an image 810. Selection of the zoom out control 815 causes the image 810 to be dynamically enlarged, as illustrated in FIG. 9, to allow the reviewing user to review an enlarged version 910 of the image if desired. Once the image has been enlarged, a zoom in control 915 is automatically displayed for allowing the user to selectively zoom the enlarged image 910 back to the reduced size image 810, illustrated in FIG. 8.

As described herein, embodiments of the present invention are directed to an improved reading mode for electronic documents. It will be apparent to those skilled in the art that various modifications or variations may be made in the present invention without departing from the scope or spirit of the invention. Other embodiments of the present invention will be apparent to those skilled in the art from consideration of the specification and practice of the invention disclosed herein.

We claim:

1. A method of displaying an electronic document in a reading mode, comprising:
displaying an electronic document in a graphical user interface, the graphical user interface having one or more selectable controls for executing one or more functions of a software application used for displaying the electronic document;
displaying the electronic document as one or more discrete document pages;
disposing a page turning control in the graphical user interface;
upon receiving a selection of the page turning control, causing a first displayed page of the electronic document to be automatically replaced with a second displayed page of the electronic document; and
displaying a page identification adjacent to the selected page turning control for identifying a presently displayed page of the electronic document.

2. The method of claim 1, further comprising receiving a selection for pinning a page of the displayed electronic document whereby upon receiving a selection for turning an adjacently displayed page of the electronic document, maintaining a display of the pinned page of the displayed electronic document while the turned adjacently displayed page is replaced with a different page of the electronic document.

3. The method of claim 1, further comprising displaying two discrete pages of the electronic document in the graphical user interface, whereby the two displayed pages are disposed in side-by-side orientation, and whereby causing a first displayed page of the electronic document to be replaced with a second displayed page of the electronic document includes causing a first two displayed pages of the electronic document to be replaced with a second two displayed pages of the electronic document.

4. The method of claim 1, further comprising suppressing from view the one or more selectable controls for showing a full screen view of the displayed electronic document.

5. The method of claim 1, further comprising receiving a held selection of the page turning control, and in response to the held selection of the page turning control, continually replacing a displayed page of the electronic document with a next page of the electronic document until the held selection of the page turning control is released.

6. The method of claim 1, further comprising defining an outside margin of a first displayed page of the electronic document as a selectable control, and in response to receiving a selection of the outside margin of the first displayed page, causing the first displayed page to be replaced with a second displayed page of the electronic document.

7. The method of claim 1, further comprising during causing a first displayed page of the electronic document to be replaced with a second displayed page of the electronic document, displaying in the graphical user interface a page turning animation for providing a visual indication that the first displayed page of the electronic document is being replaced with the second displayed page of the electronic document.

8. The method of claim 1, whereby displaying a page identification adjacent to the selected page turning control includes displaying a page number for a presently displayed page of the electronic document adjacent to the selected page turning control.

9. The method of claim 1, whereby displaying a page identification adjacent to the selected page turning control includes displaying a portion of text from the presently displayed page adjacent to the selected page turning control.

10. The method of claim 1, further comprising upon receiving a selection of a displayed portion of text contained in the displayed electronic document where a corresponding portion of text is contained in an immediate preceding or an immediately succeeding page of the electronic document that is not presently displayed, displaying the corresponding portion of text adjacent to the selected displayed portion of text.

11. The method of claim 1, further comprising in response to receiving an electronic pointer focus on a line of information contained in the displayed electronic document, disposing a reading pointer control adjacent to the focused on line of information for providing a reference point to a current reading location in the displayed document.

12. The method of claim 11, further comprising upon receiving a selection of the reading pointer control, disposing a reading line under the line of information.

13. The method of claim 1, further comprising providing a navigation control in the graphical user interface for navigating to a prescribed location in the displayed electronic document.

14. The method of claim 13, whereby providing a navigation control in the graphical user interface for navigating to a prescribed location in the displayed electronic document includes providing a navigation control for navigating to a prescribed page in the displayed electronic document.

15. The method of claim 13, whereby providing a navigation control in the graphical user interface for navigating to a prescribed location in the displayed electronic document includes providing a navigation control for navigating to a prescribed heading in the displayed electronic document.

16. The method of claim 13, whereby providing a navigation control in the graphical user interface for navigating to a prescribed location in the displayed electronic document includes providing a navigation control for navigating to a prescribed bookmark in the displayed electronic document.

17. The method of claim 1, further comprising providing a zoom control in the graphical user interface for zooming a visual display of an object contained in the displayed document to one or more display sizes for the contained object.

18. A method of displaying an electronic document in a reading mode, comprising:
displaying the electronic document as one or more discrete document pages;
defining an outside margin of a first displayed page of the electronic document as a selectable control;
in response to receiving a selection of the outside margin of the first displayed page, causing the first displayed page to be replaced with a second displayed page of the electronic document.

19. The method of claim 18, further comprising:
in response to receiving an electronic pointer focus on a line of information contained in the displayed electronic document, disposing a reading pointer control adjacent to the focused on line of information for providing a reference point to a current reading location in the displayed document; and
upon receiving a selection of the reading pointer control, disposing a reading line under the line of information.

20. A method of displaying an electronic document in a reading mode, comprising:
displaying an electronic document in a graphical user interface, the graphical user interface having one or more selectable controls for executing one or more functions of a software application used for displaying the electronic document;
suppressing from view the one or more selectable controls for showing a full screen view of the displayed electronic document;
displaying the electronic document as one or more discrete document pages;
disposing a page turning control in the graphical user interface;
upon receiving a selection of the page turning control, causing a first displayed page of the electronic document to be automatically replaced with a second displayed page of the electronic document;
displaying in the graphical user interface a page turning animation for providing a visual indication that the first displayed page of the electronic document is being replaced with the second displayed page of the electronic document; and
displaying a page identification adjacent to the selected page turning control for identifying a presently displayed page of the electronic document.
